(19) United States
(12) Patent Application Publication
(10) Pub. No.: US 2016/0249172 A1
(43) Pub. Date: Aug. 25, 2016

(54) Automated onsite information search and multimedia method and system

(71) Applicants: Alfred Xueliang Xin, Cincinnati, OH (US); Sherry Xiaoli Sun, Cincinnati, OH (US)

(72) Inventors: Alfred Xueliang Xin, Cincinnati, OH (US); Sherry Xiaoli Sun, Cincinnati, OH (US)

(21) Appl. No.: 14/630,212

(22) Filed: Feb. 24, 2015

(51) Int. Cl. H04W 4/02; H04W 4/04; G06F 17/30

(52) U.S. Cl. CPC H04W 4/025; G06F 17/30029; G06F 17/3005; H04W 4/043

(57) ABSTRACT

An automated onsite information search and multimedia method and system consists of a software application installed on a mobile device such as cellphone with wireless connection and digital map such as google map or GPS to locate physical location of a user. The software communicates with a remote server and or an onsite wireless communication apparatus with multimedia data receiving and storing; information creating, publishing and broadcasting capacities. When the user is in, at or close to a business, facility or an entity, or within a signal range of the onsite wireless apparatus, the software application plays alert sound and automatically displays information, plays video, audio programs above locked or unlocked screen. User may search specific information within or related to the business, facility or entity; or listen to and or watch alive or recorded programs provided by the business, facility or entity.

### BACKGROUND OF INVENTION

Mobile device users go to visit places such as a business, a facility or an entity with a range of functions may not be aware of all the information, services, or accurate places of products and best deals of products at those places provided. Therefore there is a need to provide them with automated system, and users don't have to do anything to have it activated and the system will show them what are offered at those places: the system would automatically alert them and automatically displays static or alive information and or performs multimedia programs, including but not limited to alive or pre-recorded audio, and or video programs.

A software application of said system may be installed on mobile electronic device such as cellphone, and it utilizes web map such as google map or GPS to locate the physical locations of the users and or identified by an onsite wireless apparatus with multimedia data receiving, storing and broadcasting capacities. Once said users are in, at or close to those places which have information or programs are available for the system, said software application alerts users and automatically displays information, plays audio and or video programs, either alive or recorded on a popup window above either locked or unlocked screen of said mobile device.

### FIELD OF THE INVENTION

The current invention is related to automated onsite information search and onsite performance of multimedia programs. The system consists of a software application installed on a mobile device such as cellphone with wireless connection and digital map such as google map or GPS to locate physical location of a user. The software communicates with a remote server and or an onsite wireless apparatus with multimedia data receiving and storing; information publishing and broadcasting capacities. When the user is in, at or close to a business, facility or an entity located by a digital map, or within a signal range of the onsite wireless apparatus, the software application plays alert sound and automatically displays information, plays video, audio programs above locked or unlocked screen of said mobile device. User may search specific information within or related to said business, facility or entity; or listen to and or watch alive or recorded video and or auto programs provided by said business, facility or entity.

### SUMMARY OF THE INVENTION

An automated onsite information search and multimedia method and system consists of a software application installed on a mobile device such as cellphone with wireless connection and digital map such as google map or GPS to locate physical location of a user.

The software communicates with a remote server and or an onsite wireless communication apparatus with multimedia data receiving and storing; information publishing and broadcasting capacities. When the user is in, at or close to a business, facility or an entity, or within a signal range of the onsite wireless communication apparatus, the software application plays alert sound and automatically displays information, plays video, audio programs above locked or unlocked screen.

User may search specific information within or related to the business, facility; or listen to and or watch alive or recorded programs provided by the business, facility or entity.

information and commercials from a third party business, a facility or an entity may be displayed on window and or played during alive or recorded video and or audio programs by said business, facility or entity.

### BRIEF DESCRIPTION OF DRAWINGS

FIG. 1-A is flow chart that demonstrates logical flows of an automated onsite information search and multimedia method and system.

FIG. 2-A displays specific position of a product located on store shelf in an aisle within a supermarket.

FIG. 2-B shown a video play on introduction of an onsite restaurant.

FIG. 2-C is a screen of a cinema's information page with names of movies.

### PREFERRED EMBODIMENT

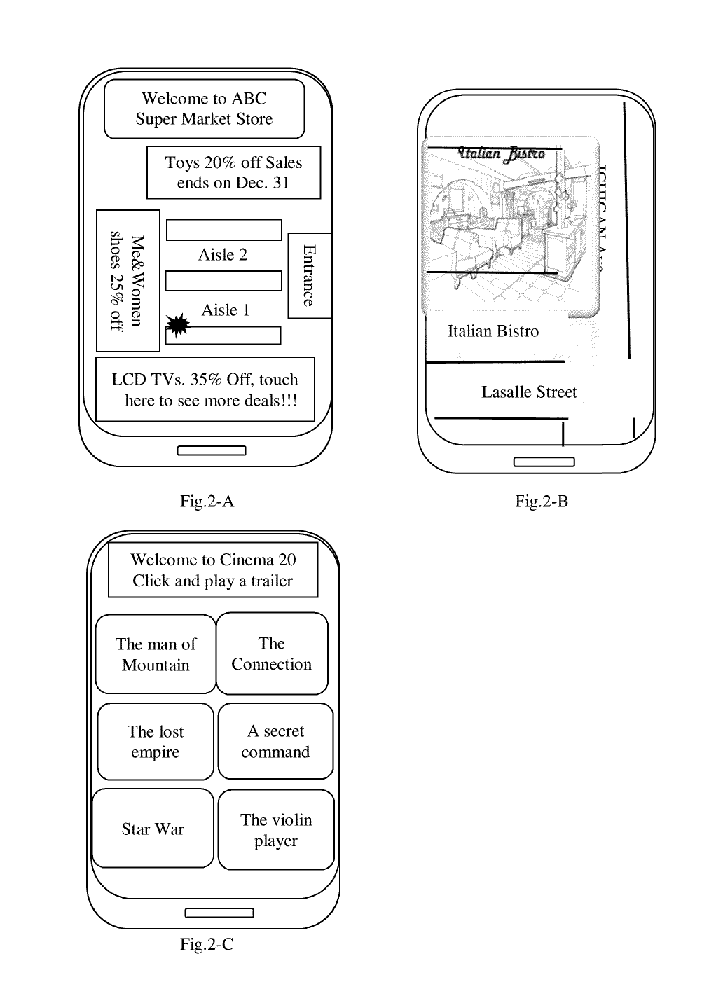

Referencing to drawings in FIG.-A and FIG. 2-A, a preferred embodiment of said automated onsite information search and multimedia system. A user with a cellphone installed with software application of an automated onsite information search and multimedia system is in a supermarket, and said user's location is pinpointed by digital map and information and media program created by the supermarket is activated and forwarded to said cellphone from a remote server.

When the user enters the supermarket, the software application plays sound alert and gets attention of said user; a pre-recorded audio announces a welcome message and new products and good deals of the market for the day with location images; and also displays a text entering box allowing shoppers to search for specific product. Said user did not use text enter box, rather speaks to the microphone on the cellphone and looking for “ACB brand coffee”, the third-party server located the product and flashing with “Star” sign on a place on a shelf in aisle 1. Said user directly goes to the place and picks up the product without wasting anytime.

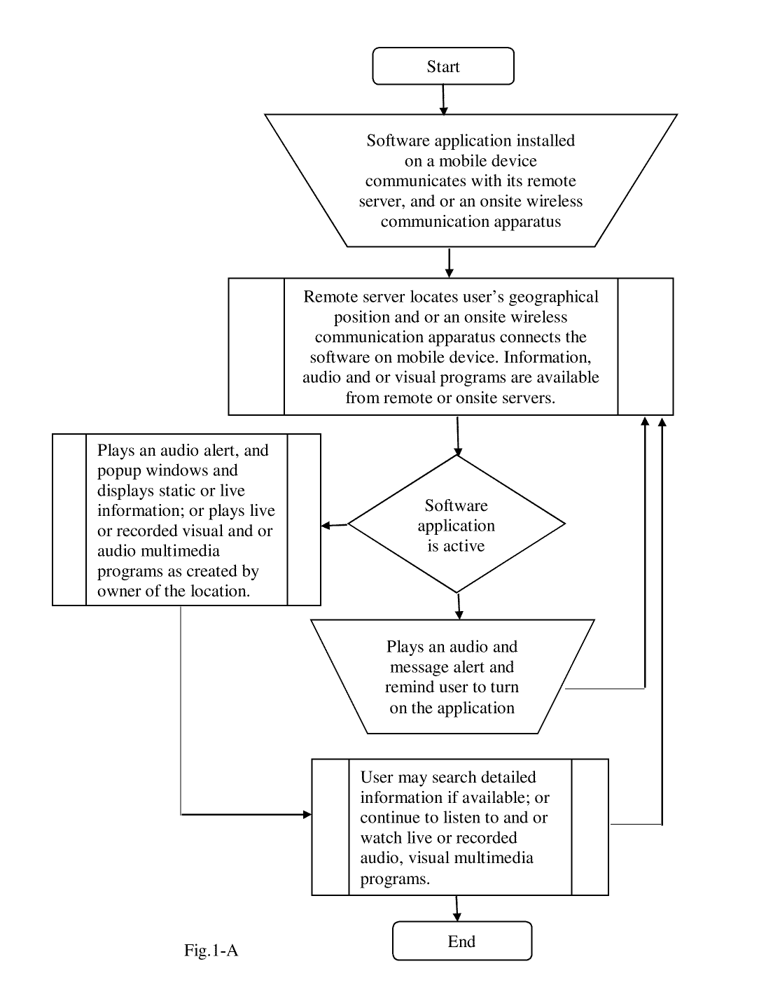

Referencing to drawings in FIG. 1-A and FIG. 2-B of another preferred embodiment of said automated onsite information search and multimedia system. A user with a cellphone installed with software application of an automated onsite information search and multimedia system is outside of restaurant and has a cellphone installed with software application of an automated onsite information search and multimedia system, and said user location and pinpointed by digital map and information and media program created by the restaurant is activated and forwarded to said cellphone from a remote server.

The software application plays sound alert and gets attention of said user; a recorded video play pops up on said cellphone screen and welcome the user and shows a brief introduction of the restaurant and also best sales dishes and best deals of the day; after said video play a menu displays on screen of said user's cellphone.

Referencing to drawings in FIG. 1-A and FIG. 2-C of another preferred embodiment of said automated onsite information search and multimedia system. A user with a cellphone installed with software application of an automated onsite information search and multimedia system is inside of cinema and said user location and pinpointed by digital map and information and media program created by said cinema is activated and forwarded to said cellphone from a remote server.

The software application plays a sound alert and gets attention of said user; a window page pops up with all the name of the movies shown on the day; an audio recording welcome said user and introduces the cinema briefly and asks said user to click on movie name and plays trailers of the movies.

The administrators of remote server of said automated onsite information search and multimedia system create and insert commercials and or information from third party businesses and said commercials and information are displayed and or played during regular information and or programs to generate extra revenues for the cinema chains.

Referencing to drawings in FIG. 1-A of another preferred embodiment of said automated onsite information search and multimedia system. A user with a cellphone installed with software application of an automated onsite information search and multimedia system is a concert hall and sitting far back in the aisle.

An onsite wireless communication apparatus with audio and video broadcasting capacities located in the concert hall and wired with a sets of video cameras sends alive video broadcasting of the performance on the stage to said cellphone and temporarily has audio and phone reception functions of the cellphone disabled in order to make sure that no noises disrupt the performance. Even though said user sits far back in the concert hall, he can clearly watch the performances on the stage.

Referencing to drawings in FIG. 1-A of another preferred embodiment of said automated onsite information search and multimedia system. A user with a cellphone installed with software application of an automated onsite information search and multimedia system is football stadium sitting in a back row.

An onsite wireless communication apparatus with audio and video broadcasting capacities located in stadium and wired with a sets of video cameras sends alive video broadcasting of the performance in the court to said cellphone. Said software application installed on said cellphone receives signals of an unique identification of said onsite wireless communication apparatus and forwards said signals to a remote sever for verification and make sure the said onsite wireless communication apparatus is licensed and authorized for alive video broadcasting with said remote server. After said remote server sends an approval signal to said software application installed on said cellphone, said software application opens a window and starts to receive and show alive video broadcasting from said onsite wireless communication apparatus. Even though said user sits a back row of the stadium, he can clearly watch the match in the field. During breaks of the match, commercials and or information of any third party are displayed on a window page or played on video screen.

Said onsite wireless communication apparatus is connected to said remote server and transferring onsite information and alive video program to said remote server. Said remote sever transfers said onsite information and alive video program to its website, and also said software application installed on said mobile device. Users of said software application from different places may select said information and alive program from said remote information and program menu option, pay a fee and read said information and watch said alive program; other audiences may also pay a fee and read and watch the same on their mobile devices, computers and TVs with internet connections.

Referencing to drawings in FIG. 1-A of another preferred embodiment of said automated onsite information search and multimedia system. A user with a cellphone installed with software application of an automated onsite information search and multimedia system gets in a resort town with no knowledge where to go.

An onsite wireless communication apparatus with audio and video broadcasting capacities located in the town center sends welcome video to said cellphone, briefly introduces the town and then display a map of the town on a window. Said user clicks on interesting places shown on the map and get detailed information about those places with static information and or recorded video clips.

Referencing to drawings in FIG. 1-A of another preferred embodiment of said automated onsite information search and multimedia system. A user with a cellphone installed with software application of an automated onsite information search and multimedia system is at an airport and trying to find information and routing to get to his flight.

An onsite wireless communication apparatus with audio and video broadcasting capacities located at the airport sends welcome video to said cellphone, briefly introduces the airport structures and then asks said user to enter his flight information by either typing into a text box on the welcome window, or give an oral command; said user speaks his flight number, said onsite wireless communication apparatus retrieves and displays flight information and boarding location from a database and drawing a map routing map for said user based on his location and leading his way to the boarding terminal, and also constantly updating flight information with streaming data shown on window.

Referencing to drawings in FIG. 1-A of another preferred embodiment of said automated onsite information search and multimedia system. A user with a cellphone installed with software application of an automated onsite information search and multimedia system is in the mountain with a group of campers and without cellphone signal, and said user gets lost in the wood.

Fortunately the organizer of the travel group brings an onsite wireless communication apparatus with audio and video broadcasting capacities and he published camp location on a map and all important information on said application window, and also alive video onsite of said camp is broadcasted. Said user looks at the software application on said cellphone, it shows where the camp center is and routes to get back to the camp center and also hears that the other member of the group talking to him over the speaker and encourage him to come back soon before it gets dark.

Referencing to drawings in FIG. 1-A of another preferred embodiment of said automated onsite information search and multimedia system. A small village or small town installed a unit of onsite wireless communication apparatus with audio and video broadcasting capacities. Instead of building up a radio station and or a TV station, said small village or small town publish information about the places and update news and also provide people in the places with alive audio and radio broadcasting when needed.

When any information and or programs are available or updated, people in the places with their cellphones installed with software application of an automated onsite information search and multimedia system will be alerted with a special ringtone and updated information and or programs are automatically shown above their locked or unlocked screens of said cellphones.

The administrators of said onsite wireless communication apparatus with audio and video broadcasting capacities create and insert commercials and or information from local businesses and said commercials and information are displayed and or played during regular information and or programs to generate revenues for said village and town.

The embodiments are mainly illustrations on the invention, advantages of the invention may be learned by practice, realized and attained by means of the elements and combinations particularly pointed out in the claims. Further it is to be understood that both the foregoing general descriptions and detailed descriptions are exemplary and explanatory only and are not limited to the invention as claimed.

It claims:

1. An automated onsite information search and multimedia method and system comprising:
a. software application installed on a mobile device such as a cellphone coupled to internet connection and a web-map such as google map or GPS (Global Position System);
b. a remote server is capable of communicating with said software application and automatically updating location of said software application; and or
c. an onsite wireless communication apparatus with multimedia data receiving and storing, information publishing and broadcasting capacities;
d. said software application is capable of receiving data and signals from said remote server and or said on-site wireless communication apparatus.

2. An automated onsite information search and multimedia method and system comprising:
a. software application installed on a mobile device such as cellphone;
b. an onsite wireless communication apparatus with multimedia data receiving and storing, information publishing and broadcasting capacities;
c. said software application is capable of receiving data and signals from said on-site wireless communication apparatus.

3. The automated onsite information search and multimedia method and system of claim 1 wherein said software application on said mobile device coupled with said web-map or GPS is capable of updating and sending accurate physical location of said mobile device to said remote server.

4. The automated onsite information search and multimedia method and system of claims 1 and 2 wherein said software application on said mobile device coupled to graphic user interface is capable of submitting a request by user for conditioned information search within a range, postal address and or at location of said mobile device; and displays requested information sent back by said remote server or said onsite wireless communication apparatus according to their actual physical locations and or actual floor layouts within a radius range of said mobile device.

5. The automated onsite information search and multimedia method and system of claims 1 and 2 wherein said software application on said mobile device may be deployed on a web browser installed to said mobile device.

6. The automated onsite information search and multimedia method and system of claims 1 and 2 wherein said software application on said mobile device is capable of displaying floor layouts within structures of a building, or layout of structures and or functional areas of a facility or an entity.

7. The automated onsite information search and multimedia method and system of claim 1 wherein said remote server is capable of submitting requests to multiple internet websites and optimizing searching results for further process.

8. The automated onsite information search and multimedia method and system of claims 1 and 2 wherein said system is capable of accepting oral commands from said user via a microphone installed on said mobile device.

9. The automated onsite information search and multimedia method and system of claims 1 and 2 wherein said software application is capable of displaying a selected information and or multimedia programs on popup windows above locked or unlocked screen of said mobile device when said user in, at or close to said business, facility or entity.

10. The automated onsite information search and multimedia method and system of claim 9 wherein said software application is capable of receiving an uniquely assigned digital code to a business; said uniquely assigned digital code is sent out by a signal emitter located within premises of said business, facility or entity; said software application sends said uniquely assigned digital code to its remote server, said remote server search any information and or multimedia programs posted and stored in its database by said business, facility or entity and sends back said information and or said multimedia programs to said software application.

11. The automated onsite information search and multimedia method and system of claim 9 wherein said software application is capable of playing a special sound, ringtone or music to alert said user.

12. The automated onsite information search and multimedia method and system of claim 9 wherein said system is capable of making said popup window disappeared from screen of said mobile device when said user walks away and or leaves said business, facility or entity from a close range, and or said assigned digital code signal weakened and replaced by another stronger assigned digital code for another business.

13. The automated onsite information search and multimedia method and system of claim 9 wherein said system is capable of announcing said information via a speaker installed on said mobile device.

14. The automated onsite information search and multimedia method and system of claims 1, 2 and 9 wherein said software application is capable of searching and selecting and displaying information from any third party related to selected business, facility or entity posted on websites on screen of said mobile device.

15. The automated onsite information search and multimedia method and system of claims 1, 2 and 9 wherein said software application is capable of playing alive or recorded video programs broadcasted by said business, facility or entity.

16. The automated onsite information search and multimedia method and system of claim 9 wherein said software application is capable of allowing user to make a phone call to said business, facility or entity via a touch button displayed on its screen on said mobile device, or via oral command.

17. The automated onsite information search and multimedia method and system of claim 1 wherein said software application is capable of communicating with preconfigured server.

18. The automated onsite information search and multimedia method and system of claims 1 and 2 Wherein said remote server and or said onsite wireless communication apparatus are capable of allowing said business, facility or entity to setup a defined physical range for their location via web interface or GUI, and allowing its information and or multimedia programs to be activated and give an alert to a user with said mobile device installed with said software application, further activate popup windows and display said information and or multimedia programs.

19. The automated onsite information search and multimedia method and system of claims 1, 2 and 9 wherein said software system is capable of playing alive or recorded video and audio announcement simultaneously.

20. The automated onsite information search and multimedia method and system of claims 1, 2 and 9 wherein said software system is capable of replacing and or switching between web Pages, windows, multimedia programs.

21. The automated onsite information search and multimedia method and system of claim 1 wherein said remote server, and or software application installed on said mobile device is capable of calculating effective physical parameter for a location or premises to activate related information and or multimedia programs by comparing and measuring said location to physical distances of other locations.

22. The on-site commercial and information media method and system of claims 1 and 9 wherein said software application installed on said mobile device is capable of detecting, and further automatically connecting to and communicating with a remote server setup for a region and or a country, and further receiving and updating commercials and information from said region and or said country.

23. The automated onsite information search and multimedia method and system of 9 wherein said software application installed on said mobile device is capable of identifying a region and or a country and automatically adopting a digital map of said region and or country.

24. The automated onsite information search and multimedia method and system of claim 9 wherein said software application installed on said mobile device is capable of identifying a region and or a country and further displaying and use language of said region and or said country.

25. The automated onsite information search and multimedia method and system of 1, 2 and 9 wherein said software application is capable of configuring, and or being added to, and or embedded with an software application applied to a mobile device.

26. The automated onsite information search and multimedia method and system of 1, 2, 8 and 9 wherein said software application coupled with said remote server and or said onsite wireless communication apparatus is capable of searching location of a specific object, service and or functional area based on map or floor-layout map.

27. The automated onsite information search and multimedia method and system of claim of 9 wherein said software application is capable of temporarily disabling ringtone, incoming phone reception and or audio function of said mobile device.

28. The automated onsite information search and multimedia method and system of claim of 1, 2 and 9 wherein information and or commercials of a third party may be inserted and displayed, and or played during an onsite alive or recorded video and or audio broadcasting.

29. The automated onsite information search and multimedia method and system of claim 2 wherein said on-site onsite wireless communication apparatus is capable of creating web or window applications, hosting and broadcasting audio and or video programs.

30. An automated onsite information search and multimedia method and system comprising steps with functions of: a software application coupled with a digital map such as google map or GPS and internet connection installed on a mobile device such as cellphone is capable of communicating with a remote server;
said remote server is capable of communicating with said software application and automatically updating location of said software application installed on said mobile device and sending information and or multimedia programs of business, facility or entity at location of said mobile;
said remote server is capable of submitting requests to multiple internet websites and optimizing searching results for further process;
said software application is capable of accepting oral commands from said user via a microphone installed on said mobile device;
said software application is capable of displaying selected information and or playing multimedia programs by said user on popup windows on screen of said mobile device when said user is in, at or close to said business, facility or entity;
said system is capable of making said popup window disappeared from screen of said mobile device when said user walks away and or leaves said business, facility or entity from a close range;
said software application is capable of playing a special sound, ringtone or music to get alert said user when said selected information and multimedia programs displayed or played on popup windows;
said software application is capable of receiving an uniquely assigned digital code to a business; said uniquely assigned digital code is sent out by a signal emitter located within premises of said business; said software application sends said uniquely assigned digital code to its host webserver, said host webserver search commercials from said business from its database and sends back to said software application;
said system is capable of announcing said selected information, alive or recorded speech or announcement via a speaker installed on said mobile device;
said software application is capable of allowing user to make a phone call to said business, facility or entity via a touch button displayed on screen of said application on said mobile device, or via oral command;
said software application is capable of communicating with an onsite wireless communication apparatus;
said onsite wireless communication apparatus is capable of composing and publishing information on web pages or windows, and or receiving and storing multimedia data, audio and or video programs, and broadcasting said programs.
